(19) United States
(12) Patent Application Publication
(10) Pub. No.: US 2026/0133458 A1
(43) Pub. Date: May 14, 2026

(54) LIQUID CRYSTAL DISPLAY DEVICE AND LIQUID CRYSTAL DISPLAY PANEL

(71) Applicant: LG DISPLAY CO., LTD., Seoul (KR)

(72) Inventors: Jaewon KIM, Cheongju-si (KR); Seoyoung PARK, Seoul (KR)

(73) Assignee: LG DISPLAY CO., LTD., Seoul (KR)

(21) Appl. No.: 19/343,858

(22) Filed: Sep. 29, 2025

(30) Foreign Application Priority Data
Nov. 14, 2024 (KR) 10-2024-0162153

(51) Int. Cl. G02F 1/1362

(52) U.S. Cl. CPC G02F 1/136295; G02F 1/136222

(57) ABSTRACT

A liquid crystal display device and a liquid crystal display panel are discussed. The liquid crystal display device can include a lower substrate having an opening area through which light is configured to transmit to implement a color, and a non-opening area in which a gate line and a common line that extend in a first direction are disposed. The display device can further include an upper substrate disposed to face the lower substrate, a liquid crystal layer disposed between the lower substrate and the upper substrate, an organic layer disposed in the non-opening area of the lower substrate, and a first column spacer and a second column spacer that are disposed on a lower surface of the upper substrate and spaced apart from each other in the first direction.

### CROSS-REFERENCE TO RELATED APPLICATION

This application claims priority to Korean Patent Application No. 10-2024-0162153, filed in the Republic of Korea on November 14, 2024, the entire contents of which are hereby expressly incorporated by reference into the present application.

### BACKGROUND

### Technical Field

The present disclosure relates to a liquid crystal display device, and more specifically, for example, without limitation, to a liquid crystal display device that is possible to prevent or minimize damage to an alignment film in an opening area due to the encroachment of column spacers into the opening area, and to a liquid crystal display panel.

### Discussion of the Related Art

Liquid crystal display devices are applied to various electronic devices such as TVs, mobile phones, notebooks, tablets, etc. A liquid crystal display device displays an image by controlling a light transmittance of a liquid crystal using an electric field. The liquid crystal display device can be classified into a vertical electric field type and a horizontal electric field type depending on a direction of an electric field that drives the liquid crystal.

The liquid crystal display device includes a color filter substrate, an array substrate, and a liquid crystal layer formed between the color filter substrate and the array substrate. In addition, the liquid crystal display device has column spacers on the color filter substrate or the array substrate to maintain a cell gap between the color filter substrate and the array substrate or prevent pressing defects.

The description provided in the description of the related art section should not be assumed to be prior art merely because it is mentioned in or associated with the description of the related art section. The description of the related art section can include information that describes one or more aspects of the subject technology, and the description in this section does not limit the disclosure.

### SUMMARY OF THE DISCLOSURE

The inventors of the present application have realized that in a related art, when an external force is applied to a liquid crystal display device, a surface of a lower alignment film of an array substrate can be damaged by movement of column spacers formed in a non-opening area of a color filter substrate. The alignment of liquid crystals can become disordered due to the damage to the lower alignment film, which can cause a light leakage defect in an area in which the basic alignment of the liquid crystals has been changed.

A liquid crystal display device has been developed in which a color filter and a black matrix that have been disposed on a color filter substrate are disposed on an array substrate. For example, a liquid crystal display device having a color filter on TFT (COT) structure has been developed. Such a COT structure has advantages of improving luminance by expanding an opening area compared to the structure according to the related art and by preventing light leakage due to bonding errors.

In some liquid crystal display devices having the COT structure, the alignment film in the opening area can be damaged by the encroachment of a column spacer into the opening area.

Accordingly, one object of the present disclosure is to provide a liquid crystal display device in which that it is possible to prevent or minimize damage to an alignment film in an opening area due to the encroachment of column spacers into the opening area.

Another object of the present disclosure is also to provide a display device in which the life can be increased, production energy needed for production can be reduced, and greenhouse gas emissions can be reduced.

Another object of the present disclosure is to provide an improved display panel and an improved display device, which can address the limitations and disadvantages associated with the related art.

Objects of the present disclosure are not limited to the above-described objects, and other objects that are not mentioned will be able to be clearly understood by those skilled in the art based on the following description.

According to example embodiments of the present disclosure, there is provided a liquid crystal display device including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, a plurality of color filters stacked on the gate line and the common line in the non-opening area of the lower substrate, an organic layer disposed on the plurality of color filters in the non-opening area of the lower substrate, and a first column spacer and a second column spacer that are disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to example embodiments of the present disclosure, there is provided a liquid crystal display device including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, an organic layer disposed on the gate line and the common line in the non-opening area of the lower substrate, and a first column spacer and a second column spacer disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to example embodiments of the present disclosure, there is provided a liquid crystal display panel including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, a plurality of color filters stacked on the gate line and the common line in the non-opening area of the lower substrate, an organic layer disposed on the plurality of color filters in the non-opening area of the lower substrate, and a first column spacer and a second column spacer that are disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to example embodiments of the present disclosure, there is provided a liquid crystal display panel including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, an organic layer disposed on the gate line and the common line in the non-opening area of the lower substrate, and a first column spacer and a second column spacer disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to the example embodiments of the present disclosure, by forming the dams on the upper surface of the organic layer covering the color filters disposed in the non-opening area and arranging the column spacers between the dams, it is possible to prevent or minimize the column spacers from encroaching the opening area and damaging the alignment film of the opening area.

In addition, according to the example embodiments of the present disclosure, by arranging the first dams around the first column spacer and the second dams around the second column spacer and forming the first dam that has a greater height than the second dam, even when an external force is applied to the extent that the first column spacer moves and climbs on the first dam, the second column spacer can be positioned to be spaced apart from the second dam or the second column spacer can be supported by the second dam, thereby preventing or minimizing the second column spacer from encroaching the opening area.

In addition, according to the example embodiments of the present disclosure, by making the heights of the second dams around the second column spacer having a higher arrangement density than the first column spacer smaller than the heights of the first dams around the first column spacer and making the lengths of the second dams around the second column spacer to have the length the same as the diameter of the second column spacer, it is possible to prevent or minimize the occurrence of spreading defect of the liquid crystal and coating defect of the alignment film due to the additional arrangement of the second dams.

In addition, according to the example embodiments of the present disclosure, since the first dams have inclined side surfaces, the first column spacer can be guided to return to its original position when an external force is removed.

According to the example embodiments of the present disclosure, it is possible to prevent or minimize a light leakage defect of the display device due to the encroachment of the column spacers into the opening area, thereby increasing the life of the display device, reducing the production energy required for producing the display device, and reducing greenhouse gas emissions.

Effects of the present disclosure are not limited to the above-described effects, and other effects that are not mentioned will be able to be clearly understood by those skilled in the art based on the above detailed description.

### BRIEF DESCRIPTION OF THE DRAWINGS

The following drawings attached to this disclosure illustrate example embodiments of the present invention and, together with the detailed description of the invention to be described below, serve to further understand the technical idea of the present invention, and therefore the present invention should not be construed as being limited to matters described in such drawings, in which:

FIG. 1 is a plan view showing sub-pixels of a display device according to one or more example embodiments of the present disclosure.

FIG. 2 is a partially enlarged view of the display device of FIG. 1.

FIG. 3 is a cross-sectional view of the display device along line III-III’ in FIG. 2.

FIG. 4 is a cross-sectional view of the display device along line IV-IV’ in FIG. 2.

FIG. 5 is a cross-sectional view of the display device along line V-V’ in FIG. 2.

FIGS. 6 and 7 are cross-sectional views showing a case in which an external force is applied to the display device according to one example embodiment of the present disclosure.

FIG. 8 is a view for describing a method of manufacturing a display device according to one example embodiment of the present disclosure.

FIG. 9 is a cross-sectional view of the display device according to one example embodiment of the present disclosure.

FIG. 10 is a view for describing a method of manufacturing a display device according to one example embodiment of the present disclosure.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Reference will now be made in detail to embodiments of the present disclosure, examples of which can be illustrated in the accompanying drawings. The progression of processing steps and/or operations described is an example; however, the sequence of steps and/or operations is not limited to that set forth herein and can be changed as is known in the art, with the exception of steps and/or operations necessarily occurring in a particular order. Names of the respective elements used in the following explanations can be selected only for convenience of writing the disclosure and can be thus different from those used in actual products.

Advantages and features of the present disclosure and methods for achieving them will become clear by referencing embodiments described below in detail in conjunction with the accompanying drawings. However, the present disclosure is not limited to the embodiments disclosed below but will be implemented in various different forms, these embodiments are merely provided to make the disclosure of the present disclosure complete and fully inform those skilled in the art to which the present disclosure pertains of the scope of the present disclosure.

Since shapes, sizes, dimensions (e.g., length, width, height, thickness, radius, diameter, area, etc.), ratios, angles, numbers, etc. disclosed in the drawings for describing the embodiments of the present disclosure are illustrative, the present disclosure is not limited to the shown items.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

The same reference number denotes the same components throughout the disclosure. In addition, in describing the present disclosure, when it is determined that the detailed description of a related known technology can unnecessarily obscure the gist of the present disclosure, the detailed description thereof will be omitted. When terms such as “include,” “have,” “comprise,” “contain,” “constitute,” “make up of,” “formed of,” and “consist of” or the like described herein are used, other parts can be added unless “only” is used. When a component is expressed in a singular form, it includes a case in which the component is provided as a plurality of components unless specifically stated otherwise.

In construing a component, the component is construed as including a margin of error even when there is no separate explicit description related to the margin of error.

When the positional relationship is described, for example, when the positional relationship between two parts is described using terms such as “on”, “above”, “over”, “below”, “under”, “beside”, “beneath”, “near”, “close to,” “adjacent to”, “on a side of”, “next” or the like, one or more other parts can be positioned between the two parts, for example, unless “immediately,” “directly,” or “close to” is used.

When the temporal relationship is described, when the temporal relationship is described using terms such as “after,” “subsequently,” “then,” “before,” or the like, it can also include a non-consecutive case unless “immediately” or “directly” is used.

Although terms such as first and second are used to describe various components, these components are not limited by these terms. These terms are only used to distinguish one component from another component. Therefore, a first component described below can be a second component within the technical spirit of the present disclosure.

In the description of components of the present disclosure, terms such as first, second, A, B, (a), and (b) can be used. These terms are only for the purpose of distinguishing one component from another component, and the nature, sequence, order, or the like of the corresponding component is not limited by these terms.

When a certain component is described as being “connected,” “coupled,” “joined,” or “attached” to another component, the certain component can be connected, coupled, joined, or attached directly to another component, but it should be understood that still another component can be interposed between components that can be connected, coupled, joined, or attached indirectly unless otherwise stated specially.

When a component or a layer is described as “coming into contact with” or “overlapping” another component or layer, the component or the layer can come into direct contact with or directly overlap another component or layer, but it should be understood that still another component can be interposed between components that can come into indirect contact with and indirectly overlap each other unless otherwise stated specially.

It should be understood that “at least one” includes any combination of one or more of associated components. For example, “at least one of first, second, and third components” can include not only the first, second, or third component, but also any combination of two or more of the first, second, and third components.

The terms such as “first direction,” “second direction,” “third direction,” “X-axis direction,” “Y-axis direction,” and “Z-axis direction” should not be construed as merely the geometric relationship in which the relationship therebetween is perpendicular and can refer to a wider directionality within the range in which the configuration of the present disclosure can act functionally.

A term “device” used herein can refer to a display device including a display panel and a driver for driving the display panel. Examples of the display device can include a light emitting element, and the like. In addition, examples of the device can include a notebook computer, a television, a computer monitor, an automotive device, a wearable device, and an automotive equipment device, and a set electronic device (or apparatus) or a set device (or apparatus), for example, a mobile electronic device such as a smartphone or an electronic pad, which are complete products or final products respectively including light emitting element and the like, but embodiments of the present disclosure are not limited thereto.

Features of various embodiments of the present disclosure can be coupled or combined partially or entirely, various technological interworking and driving are made possible, and the embodiments can be implemented independently of each other or implemented together in an associated relationship.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein.

In the aspects of the present disclosure, a source electrode and a drain electrode are distinguished from each other, for convenience of description. However, the source electrode and the drain electrode are used interchangeably. The source electrode can be the drain electrode, and the drain electrode can be the source electrode. Further, the source electrode in any one aspect of the present disclosure can be the drain electrode in another aspect of the present disclosure, and the drain electrode in any one aspect of the present disclosure can be the source electrode in another aspect of the present disclosure.

Hereinafter, various example embodiments of the present disclosure will be described in detail with reference to the accompanying drawings. All the components of each display device/apparatus/panel according to all embodiments of the present disclosure are operatively coupled and configured.

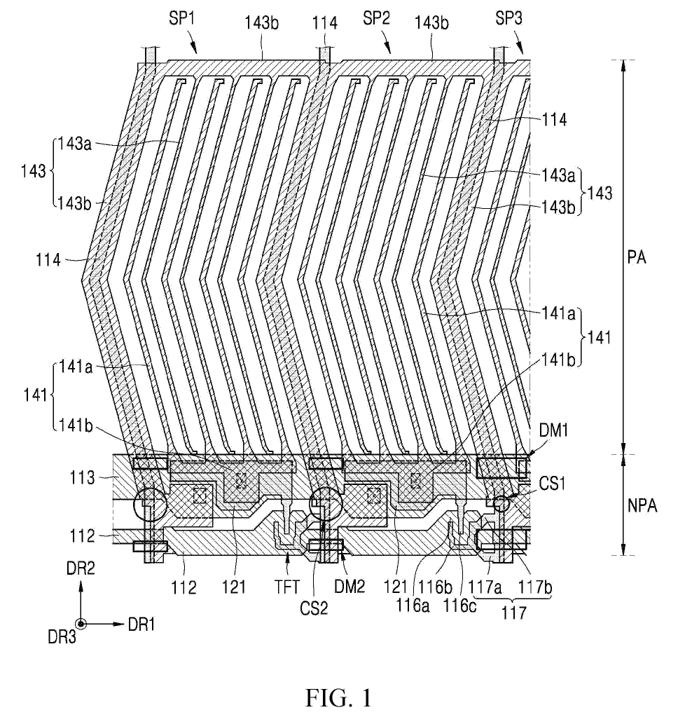

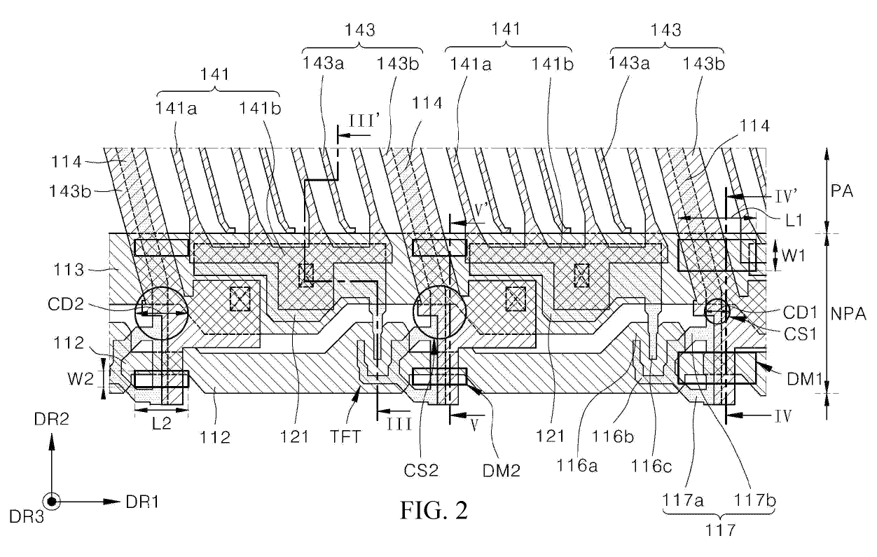

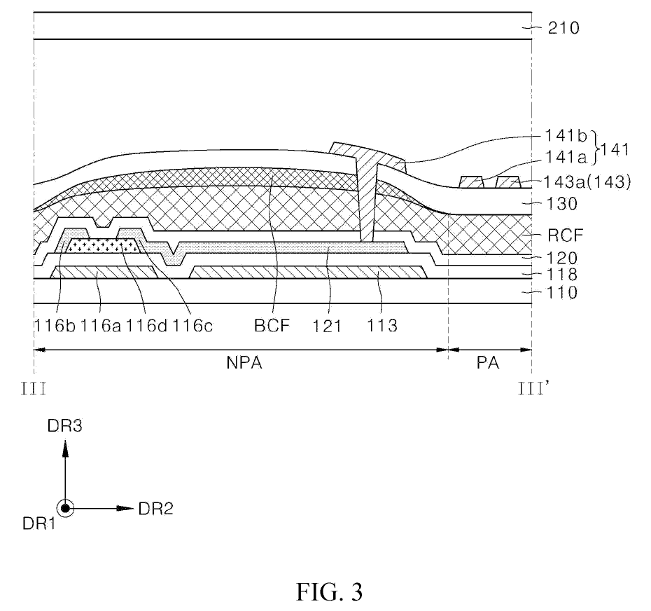

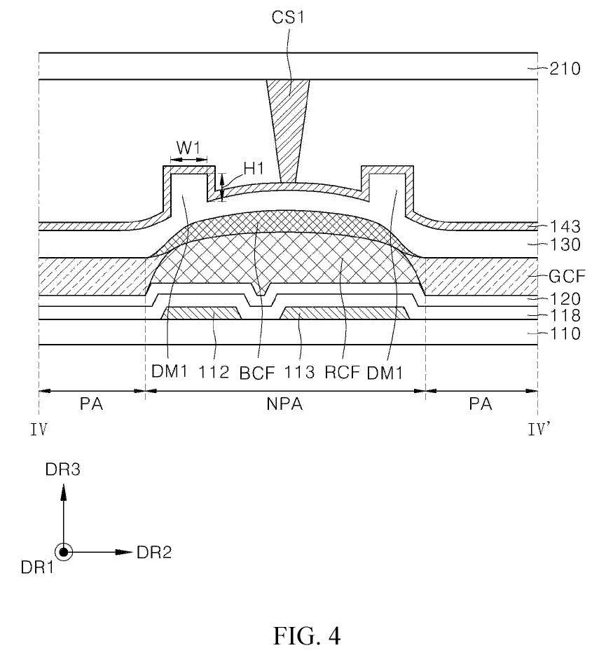

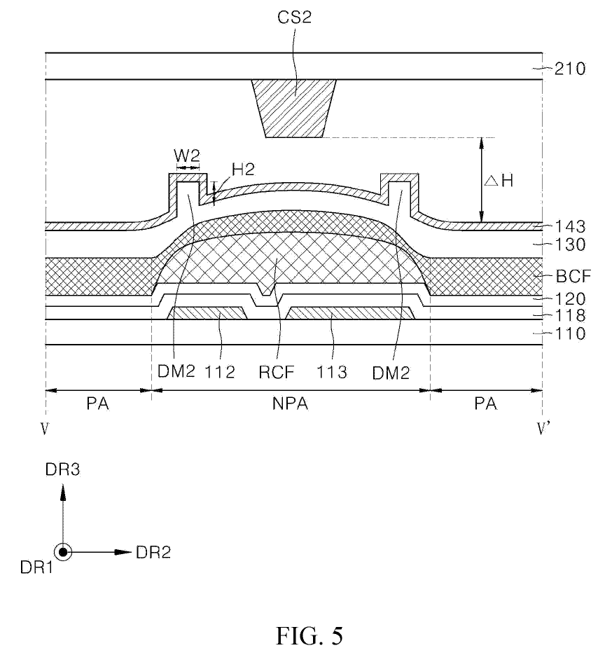

FIG. 1 is a plan view of a liquid crystal display device according to one or more example embodiments of the present disclosure. FIG. 2 is a partially enlarged view of the display device of FIG. 1. FIG. 3 is a cross-sectional view of the display device along line III-III’ in FIG. 2. FIG. 4 is a cross-sectional view of the display device along line IV-IV’ in FIG. 2. FIG. 5 is a cross-sectional view of the display device along line V-V’ in FIG. 2. A liquid crystal display device according to one or more example embodiments of the present disclosure will be described as being a fringe field switching (FFS) type liquid crystal display device, but is not limited thereto, and can be an in-plane switching (IPS) type liquid crystal display device. Further, in other examples, the display device can also be a different type of display device.

Referring to FIG. 1, the liquid crystal display device according to one or more example embodiments of the present disclosure includes gate lines 112 and data lines 114 that intersect each other, a common line 113 adjacent to the gate line 112, and a thin film transistor TFT positioned in an intersection area of the gate line 112 and the data line 114. A plurality of sub-pixels can be defined by the intersection structure of the gate lines 112 and the data lines 114. Each sub-pixel can include an opening area PA through which light can transmit to implement colors, and a non-opening area NPA through which light may not transmit. The gate line 112, the common line 113, and a thin film transistor TFT can be disposed in the non-opening area NPA. The opening area PA and the non-opening area NPA can be areas of a lower substrate. The liquid crystal display device according to one example embodiment of the present disclosure can include three sub-pixels, for example, a red sub-pixel SP1, a green sub-pixel SP2, and a blue sub-pixel SP3.

The sub-pixels can also include white sub-pixel. The plurality of subpixels can be variously modified in colors and configurations, as necessary. However, the present disclosure is not limited thereto.

For example, the plurality of subpixels can include red, green, and blue subpixels, in which the red, green, and blue subpixels can be disposed in a repeated manner. Alternatively, the plurality of subpixels can include red, green, blue, and white subpixels, in which the red, green, blue, and white subpixels can be disposed in a repeated manner, or the red, green, blue, and white subpixels can be disposed in a quad type. For example, the red sub pixel, the blue sub pixel, and the green sub pixel can be sequentially disposed along a row direction, or the red sub pixel, the blue sub pixel, the green sub pixel and the white sub pixel can be sequentially disposed along the row direction. However, in the embodiment of the present disclosure, the color type, disposition type, and disposition order of the subpixels are not limiting, and can be configured in various forms according to light-emitting characteristics, device lifespans, and device specifications.

The subpixels can have different light-emitting areas according to light-emitting characteristics. For example, a subpixel that emits light of a color different from that of a blue subpixel can have a different light-emitting area from that of the blue subpixel. For example, the red subpixel, the blue subpixel, and the green subpixel, or the red subpixel, the blue subpixel, the white subpixel, and the green subpixel can each has a different light-emitting area.

The gate line 112 can extend in a first direction DR1. The data line 114 can extend in a second direction DR2 intersecting the first direction DR1. The data line 114 can have a bent structure.

The common line 113 can be disposed adjacent to an upper or lower side of the gate line 112 in the plan view. The common line 113 can extend parallel to the gate line 112.

Each of the sub-pixels SP1, SP2, and SP3 includes the thin film transistor TFT connected to the gate line 112 and the data line 114. The thin film transistor TFT includes a gate electrode 116a extending from the gate line 112, a source electrode 116b extending from the data line 114 and disposed, for example, in a “U” shape on the gate electrode 116a, and a drain electrode 116c spaced a predetermined distance from the source electrode 116b and extending to the inside of the “U”-shaped pattern of the source electrode 116b. In this case, a semiconductor layer is interposed between a layer of the gate electrode 116a and layers of the source/drain electrodes 116b and 116c.

The source electrode 116b can be connected to the data line 114 by a source connection pattern 117. For example, the source connection pattern 117 can include two patterns 117a and 117b positioned on both sides of the gate line 112.

The gate line 112 having the gate electrode 116a and the common line 113 can be formed on the same plane or the same layer, but are not limited thereto.

All of the data line 114, the source/drain electrodes 116b and 116c, and a conductive pattern 121 extending from the drain electrode 116c can be formed on the same plane or the same layer, but are not limited thereto.

Each of the sub-pixels SP1, SP2, and SP3 includes a first electrode 141 electrically connected to the drain electrode 116c of the thin film transistor TFT, and a second electrode 143 electrically connected to the common line 113. For example, the first electrode 141 and the second electrode 143 can be positioned on the same plane, but are not limited thereto.

A data voltage is supplied to the first electrode 141 through the data line 114. A reference voltage for driving liquid crystals, for example, a common voltage, is supplied to the second electrode 143 through the common line 113. Accordingly, an electric field is generated between the first electrode 141 to which the data voltage is supplied and the second electrode 143 to which the common voltage is supplied. In addition, a light transmittance of the opening area PA of the sub-pixel varies depending on a degree of rotation of liquid crystal molecules according to the electric field. The first electrode 141 can be a pixel electrode, and the second electrode 143 can be a common electrode.

The first electrode 141 can include two or more first branches 141a and first connection portions 141b connecting the first branches 141a. The first branches 141a of the first electrode 141 can have a bent structure. The second electrode 143 can include two or more second branches 143a and second connection portions 143b connecting the second branches 143a. The second branches 143a of the second electrode 143 can have a bent structure. The second connection portion 143b can have a portion overlapping the data line 114. The branches 141a of the first electrode 141 and the branches 141a of the second electrode 143 can be alternately disposed in the opening area PA of the sub-pixel. Since the first electrode 141 and the second electrode 143 have a bent structure, the liquid crystal molecules are aligned in two directions to form two domains, thereby further improving a viewing angle compared to a mono domain. However, the example embodiments of the present disclosure are not limited to the liquid crystal display device having a two-domain structure and can be a liquid crystal display device having a multi-domain structure including two or more domains as well as a mono-domain structure.

The first electrode 141 can be electrically connected to the conductive pattern 121 extending from the drain electrode 116c through a contact hole passing through an insulating layer disposed on the drain electrode 116c and the conductive pattern 121. The conductive pattern 121 can overlap a part of the common line 113. Accordingly, the conductive pattern 121 and the common line 113 can serve as a storage capacitor that retains a data voltage supplied through the data line 114 until the next frame.

The second electrode 143 can be electrically connected to the common line 113 through a contact hole passing through an insulating layer disposed on the common line 113.

The liquid crystal display device according to one example embodiment of the present disclosure can include a first column spacer CS1, a first dam DM1, a second column spacer CS2, and a second dam DM2. The first column spacer CS1, the first dam DM1, the second column spacer CS2, and the second dam DM2 can be disposed in the non-opening area NPA.

The first column spacer CS1 can be disposed in a space provided between two first dams DM1 spaced apart from each other in the second direction DR2. The first column spacer CS1 can be a gap spacer for maintaining a constant cell gap between the lower substrate and an upper substrate.

The second column spacer CS2 can be disposed in a space provided between two first dams DM2 disposed to be spaced apart from each other in the second direction DR2. The second column spacer CS2 can be a push spacer for preventing or minimizing deformation in which the cell gap becomes excessively narrow due to an external force.

An arrangement density of the first column spacer CS1 can be smaller than an arrangement density of the second column spacer CS2. A height of the second column spacer CS2 can be smaller than a height of the first column spacer. As shown in FIG. 1, the first column spacer CS1 and the second column spacer CS2 can be disposed in a boundary area of the sub-pixels, but are not limited thereto.

Referring to FIG. 2, the first dams DM1 can have a bar shape having a first length L1 in the first direction DR1 and a first width W1 in the second direction DR2. A first width W1 of the first dams DM1 can be larger than a diameter CD1 of the first column spacer CS1. The first lengths L1 of the first dams DM1 can be larger than the diameter CD1 of the first column spacer CS1.

The second dams DM2 can have a bar shape having a second length L2 in the first direction DR1 and a second width W2 in the second direction DR2. Second widths W2 of the second dams DM2 can be smaller than a diameter CD2 of the second column spacer CS2. The second lengths L2 of the second dams DM2 can be the same as the diameter CD2 of the second column spacer CS2. By making the second lengths L2 of the second dams DM2 around the second column spacer CS2 having a higher arrangement density than the first column spacer CS1 the same as the diameter CD2 of the second column spacer CS2, it is possible to prevent or minimize the liquid crystal spreading defect and the alignment film coating defect from occurring due to the additional arrangement of the second dams DM2.

Referring to FIGS. 2 and 3, the gate electrode 116a and the common line 113 can be disposed on the non-opening area NPA of a lower substrate 110 of the liquid crystal display device according to the example embodiment of the present disclosure. As described above, the gate electrode 116a can extend from the gate line 112. The lower substrate 110 can be formed of transparent glass or plastic. For example, the lower substrate 110 can include a flexible polymer film. For example, the flexible polymer film can be made of any one of polyimide (PI), polyethylene terephthalate (PET), acrylonitrile-butadiene-styrene copolymer(ABS), polymethyl methacrylate(PMMA), polyethylene naphthalate (PEN), polycarbonate (PC), polyethersulfone (PES), polyarylate (PAR), polysulfone (PSF), cyclic olefin copolymer(COC), triacetylcellulose(TAC), polyvinyl alcohol(PVA), and polystyrene(PS), and the present disclosure is not limited thereto.

A gate insulating layer 118 can be disposed on the gate electrode 116a and the common line 113. The gate insulating layer 118 can be disposed in the non-opening area NPA and the opening area PA of the lower substrate 110. The gate insulating layer 118 can be formed of an inorganic insulating material. For example, the gate insulating layer 118 can be composed of a single layer or multiple layers of silicon oxide (SiOx) or silicon nitride (SiNx). For example, the gate insulating layer 118 can be formed by inorganic film in a single layer or in multiple layers, for example, the inorganic film in a single layer can be a silicon oxide (SiOx) film or a silicon nitride (SiNx) film, and inorganic films in multiple layers can formed by alternately stacking one or more silicon oxide (SiOx) films, one or more silicon nitride (SiNx) films, and one or more amorphous silicon (a-Si), but the example embodiments of the present disclosure are not limited thereto.

A semiconductor layer 116d overlapping the gate electrode 116a can be disposed on the gate insulating layer 118. The semiconductor layer 116d can include amorphous silicon, polycrystalline silicon, or an oxide semiconductor.

The oxide semiconductor material can have an excellent effect of preventing or minimizing a leakage current and relatively inexpensive manufacturing cost. The oxide semiconductor can be made of a metal oxide such as zinc (Zn), indium (In), gallium (Ga), tin (Sn), and titanium (Ti) or a combination of a metal such as zinc (Zn), indium (In), gallium (Ga), tin (Sn), or titanium (Ti) and its oxide. Specifically, the oxide semiconductor can include zinc oxide (ZnO), zinc-tin oxide (ZTO), zinc-indium oxide (ZIO), indium oxide (InO), titanium oxide (TiO), indium-gallium-zinc oxide (IGZO), indium-zinc-tin oxide (IZTO), indium zinc oxide (IZO), indium gallium tin oxide (IGTO), and indium gallium oxide (IGO), but is not limited thereto.

The polycrystalline semiconductor material has a fast movement speed of carriers such as electrons and holes and thus has high mobility, and has low energy power consumption and superior reliability. The polycrystalline semiconductor can be made of polycrystalline silicon (poly-Si), but is not limited thereto.

The amorphous semiconductor material can be made of amorphous silicon (a-Si), but is not limited thereto.

The source electrode 116b can be disposed on a part of the semiconductor layer 116d, and the drain electrode 116c can be disposed on the other part of the semiconductor layer 116d. An ohmic contact layer can be interposed between the semiconductor layer 116d and the source electrode 116b and between the semiconductor layer 116d and the drain electrode 116c.

A conductive pattern 121 can be disposed on the gate insulating layer 118 to overlap the common line 113. The conductive pattern 121 can extend from the drain electrode 116c. The common line 113 and the conductive pattern 121 can form a storage capacitor.

A passivation layer 120 can cover the source electrode 116b, the drain electrode 116c, and the conductive pattern 121 and can be disposed on the gate insulating layer 118. The passivation layer 120 can be disposed in the non-opening area NPA and the opening area PA of the lower substrate 110. For example, the passivation layer 120 can be composed of a single layer or multiple layers of silicon oxide (SiOx) or silicon nitride (SiNx) which is an inorganic film material, but the example embodiments of the present disclosure are not limited thereto. For example, the passivation layer 120 can be a protective layer or an insulating layer, but the example embodiments of the present disclosure are not limited thereto.

A red color filter RCF can be disposed on the passivation layer 120. The red color filter RCF can also be disposed in the non-opening area NPA and the opening area PA of the lower substrate 110. A blue color filter BCF can be disposed on the red color filter RCF in the non-opening area NPA of the lower substrate 110. The red color filter RCF and the blue color filter BCF disposed to overlap each other in the non-opening area NPA of the lower substrate 110 can serve as a black matrix that blocks the transmission of visible light.

An organic layer 130 can be disposed on the red color filter RCF and the blue color filter BCF. For example, the organic layer 130 can be formed of a material such as an acryl-based material, an epoxy-based material, a phenolic-based material, a polyamide-based material, or a polyimide-based material, but not limited thereto. The organic layer 130 can be formed of a photosensitive organic insulation material. For example, the organic layer 130 can be formed of photo acryl.

The first electrode 141 and the second electrode 143 can be disposed on the organic layer 130. The first connection portion 141b of the first electrode 141 can be connected to the conductive pattern 121 by passing through the organic layer 130, the blue color filter BCF, the red color filter RCF, and the passivation layer 120 in the non-opening area NPA of the lower substrate 110. The second connection portion of the second electrode 143 can be connected to the common line 113 by passing through the organic layer 130, the blue color filter BCF, the red color filter RCF, the passivation layer 120, and the gate insulating layer 118 in the non-opening area NPA of the lower substrate 110. The first branch 141a of the first electrode 141 and the second branch 143a of the second electrode 143 can be disposed in the opening area PA of the lower substrate 110. The first electrode 141 and the second electrode 143 can be formed of a transparent conductive oxide, for example, including indium-tin-oxide (ITO) and indium-zinc-oxide (IZO), but not limited thereto.

An alignment film covering the first electrode 141 and the second electrode 143 can be disposed on the organic layer 130.

An upper substrate 210 can be disposed on the organic layer 130. An alignment film can be disposed on a lower surface of the upper substrate 210. A liquid crystal layer can be disposed between the organic layer 130 and the upper substrate 210.

Referring to FIGS. 2 and 4, the gate electrode 112 and the common line 113 can be disposed in the non-opening area NPA of the lower substrate 110 of the liquid crystal display device according to the example embodiment of the present disclosure.

The gate insulating layer 118 can be disposed on the gate line 112 and the common line 113. The gate insulating layer 118 can be disposed in the non-opening area NPA and the opening area PA of the lower substrate 110. The gate insulating layer 118 can be formed of an inorganic insulating material. For example, the gate insulating layer 118 can be composed of a single layer or multiple layers of silicon oxide (SiOx) or silicon nitride (SiNx). For example, the gate insulating layer 118 can be formed by inorganic film in a single layer or in multiple layers, for example, the inorganic film in a single layer can be a silicon oxide (SiOx) film or a silicon nitride (SiNx) film, and inorganic films in multiple layers can formed by alternately stacking one or more silicon oxide (SiOx) films, one or more silicon nitride (SiNx) films, and one or more amorphous silicon (a-Si), but the example embodiments of the present disclosure are not limited thereto.

The passivation layer 120 can be disposed on the gate insulating layer 118. The passivation layer 120 can be disposed in the non-opening area NPA and the opening area PA of the lower substrate 110. For example, the passivation layer 120 can be composed of a single layer or multiple layers of silicon oxide (SiOx) or silicon nitride (SiNx) which is an inorganic film material, but the example embodiments of the present disclosure are not limited thereto. For example, the passivation layer 120 can be a protective layer or an insulating layer, but the example embodiments of the present disclosure are not limited thereto.

The red color filter RCF and the green color filter GCF can be disposed on the passivation layer 120. The red color filter RCF can be disposed in the non-opening area NPA of the lower substrate 110. The green color filter GCF can be disposed in the opening area PA of the lower substrate 110. The blue color filter BCF can be disposed on the red color filter RCF in the non-opening area NPA of the lower substrate 110. The red color filter RCF and the blue color filter BCF disposed to overlap each other in the non-opening area NPA of the lower substrate 110 can serve as a black matrix that blocks the transmission of visible light.

The organic layer 130 can be disposed on the red color filter RCF and the blue color filter BCF. For example, the organic layer 130 can be formed of a material such as an acryl-based material, an epoxy-based material, a phenolic-based material, a polyamide-based material, or a polyimide-based material, but not limited thereto. The organic layer 130 can be formed of a photosensitive organic insulation material. For example, the organic layer 130 can be formed of photo acryl.

The organic layer 130 can include two first dams DM1 spaced apart from each other in the second direction DR2. The first dams DM1 can protrude from an upper surface of the organic layer 130. The first dams DM1 can be formed integrally with the organic layer 130. The first dams DM1 can have the first width W1 and a first height H1. The first width W1 can be a width in the second direction DR2. The first height H1 can be the shortest distance from an upper end of the first dam DM1 to the upper surface of the organic layer 130. The first height H1 can be a height of an inner side surface of the first dam DM1. The inner side surface of the first dams DM1 can be a side surface facing to another adjacent first dam DM1. The first width W1 can be a distance between side surfaces facing to each other of any one of the two first dams DM1. For example, the first width W1 can be a shortest distance between side surfaces facing to each other of any one of the two first dams DM1. The two first dams DM1 of the organic layer 130 can be disposed in the non-opening area NPA of the lower substrate 110. One first dam DM1 can overlap the gate line 112. The other first dam DM1 can overlap the common line 113.

The second electrode 143 can be disposed on the organic layer 130 including the two first dams DM1. A lower alignment film can be disposed on the second electrode 143.

The upper substrate 210 can be disposed on the organic layer 130. The first column spacer CS1 can be disposed on the lower surface of the upper substrate 210. An upper alignment film covering the first column spacer CS1 can be disposed on the lower surface of the upper substrate 210. The liquid crystal layer can be disposed between the organic layer 130 and the upper substrate 210.

The first column spacer CS1 can be disposed between the two first dams DM1. The first dams DM1 can restrict movement of the first column spacer CS1 when an external force is applied to the liquid crystal display device, thereby preventing or minimizing the first column spacer CS1 from encroaching the opening area PA and damaging the alignment film.

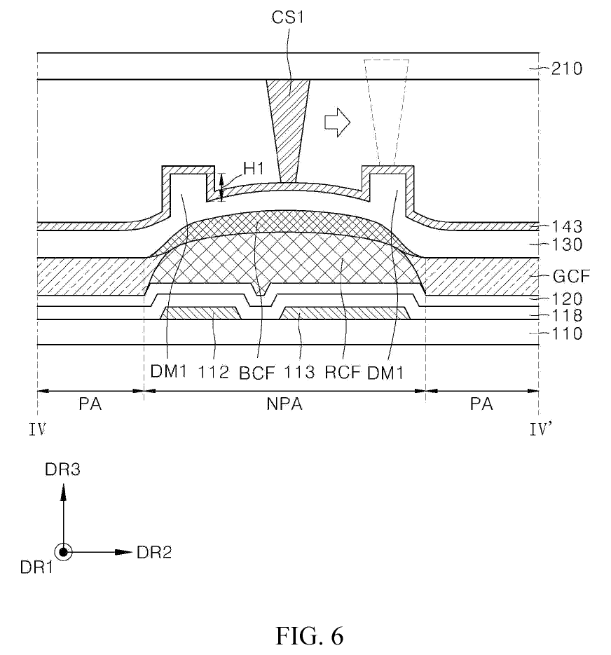

The first widths W1 of the first dams DM1 are preferably larger than the width or diameter (of a lower end portion) of the first column spacer CS1. As shown in FIG. 6, when a large external force is applied to the liquid crystal display device and the first column spacer CS1 shifts and climbs the first dam DM1, the first column spacer CS1 can be stably supported by the first dam DM1.

Referring to FIGS. 2 and 5, the gate electrode 112 and the common line 113 can be disposed in the non-opening area NPA of the lower substrate 110 of the liquid crystal display device according to the example embodiment of the present disclosure.

The gate insulating layer 118 can be disposed on the gate line 112 and the common line 113. The gate insulating layer 118 can be disposed in the non-opening area NPA and the opening area PA of the lower substrate 110. The gate insulating layer 118 can be formed of an inorganic insulating material. For example, the gate insulating layer 118 can be composed of a single layer or multiple layers of silicon oxide (SiOx) or silicon nitride (SiNx). For example, the gate insulating layer 118 can be formed by inorganic film in a single layer or in multiple layers, for example, the inorganic film in a single layer can be a silicon oxide (SiOx) film or a silicon nitride (SiNx) film, and inorganic films in multiple layers can formed by alternately stacking one or more silicon oxide (SiOx) films, one or more silicon nitride (SiNx) films, and one or more amorphous silicon (a-Si), but the example embodiments of the present disclosure are not limited thereto.

The passivation layer 120 can be disposed on the gate insulating layer 118. The passivation layer 120 can be disposed in the non-opening area NPA and the opening area PA of the lower substrate 110. For example, the passivation layer 120 can be composed of a single layer or multiple layers of silicon oxide (SiOx) or silicon nitride (SiNx) which is an inorganic film material, but the example embodiments of the present disclosure are not limited thereto. For example, the passivation layer 120 can be a protective layer or an insulating layer, but the example embodiments of the present disclosure are not limited thereto.

The red color filter RCF and the blue color filter BCF can be disposed on the passivation layer 120. The red color filter RCF can be disposed in the non-opening area NPA of the lower substrate 110. The blue color filter BCF can also be disposed in the non-opening area NPA and the opening area PA of the lower substrate 110. The blue color filter BCF can be disposed on the red color filter RCF in the non-opening area NPA of the lower substrate 110. The red color filter RCF and the blue color filter BCF disposed to overlap each other in the non-opening area NPA of the lower substrate 110 can serve as a black matrix that blocks the transmission of visible light.

The organic layer 130 can be disposed on the blue color filter BCF. For example, the organic layer 130 can be formed of a material such as an acryl-based material, an epoxy-based material, a phenolic-based material, a polyamide-based material, or a polyimide-based material, but not limited thereto. The organic layer 130 can be formed of a photosensitive organic insulation material. For example, the organic layer 130 can be formed of photo acryl.

The organic layer 130 can include two second dams DM2. The second dams DM2 can protrude from the upper surface of the organic layer 130. The second dams DM2 can be formed integrally with the organic layer 130. The second dams DM2 can have the second width W2 and a second height H2. The second width W2 can be a width in the second direction DR2. The second height H2 can be the shortest distance from an upper end of the second dam DM2 to the upper surface of the organic layer 130. The second height H2 can be a height of an inner side surface of the second dam DM2. The inner side surface of the second dam DM2 can be a side surface facing to another adjacent second dam DM2. The second width W2 can be a distance between side surfaces facing to each other of any one of the two second dam DM2. For example, the second width W2 can be a shortest distance between side surfaces facing to each other of any one of the two second dam DM2. The two second dams DM2 of the organic layer 130 can be disposed in the non-opening area NPA of the lower substrate 110. One second dam DM2 can overlap the gate line 112. The other second dam DM2 can overlap the common line 113.

To prevent or minimize a decrease in an aperture ratio, the second width W2 of the second dam DM2 is preferably smaller than the first width W1 of the first dam DM1. A gap between the second column spacer CS2 and the second dam DM2 can be larger than or equal to a gap between the first column spacer CS1 and the first dam DM1. Accordingly, when the first column spacer CS1 climbs the first dam DM1 by an external force, a part of the second column spacer CS2 can overlap the second dam DM2 and can be positioned on the second dam DM2.

The second height H2 of the second dam DM2 is preferably smaller than the first height H1 of the first dam DM1. Since the second dam DM2 is disposed to correspond to the second column spacer, CS2 having a high arrangement density, by making the second height H2 of the second dam DM2 lower than the first height H1 of the first dam DM1, it is possible to prevent or minimize the liquid crystal spreading defect, the alignment film coating defect, and the rubbing process defect from occurring due to the additional arrangement of the second dams DM2.

The second electrode 143 can be disposed on the organic layer 130 including the two second dams DM2. An alignment film can be disposed on the second electrode 143.

The upper substrate 210 can be disposed on the organic layer 130. The second column spacer CS2 can be disposed on the lower surface of the upper substrate 210. An alignment film covering the second column spacer CS2 can be disposed on the lower surface of the upper substrate 210. The height of the second column spacer CS2 can be smaller than the height of the first column spacer CS1. In a state in which no external force is applied to the liquid crystal display device, the second column spacer CS2 can be spaced a predetermined distance from the lower alignment film disposed on the lower substrate 110. The liquid crystal layer can be disposed between the organic layer 130 and the upper substrate 210.

The second column spacer CS2 can be disposed between the two second dams DM2. The second dams DM2 can prevent or minimize the second column spacer CS2 from encroaching the opening area PA and damaging the lower alignment film when an external force is applied to the liquid crystal display device.

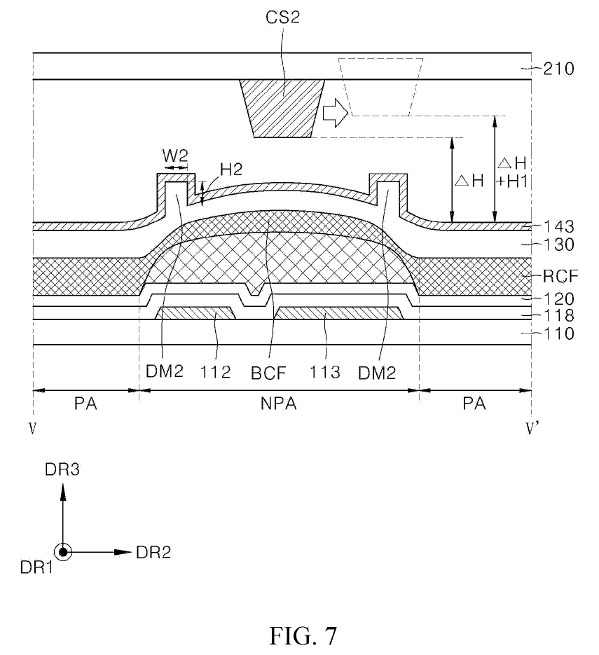

Referring to FIG. 6, when a large external force is applied to the liquid crystal display device and the first column spacer CS1 shifts and climbs the first dam DM1, as shown in FIG. 7, the second column spacer CS2 can also shift the same distance and can be positioned to be spaced apart from the second dam DM2. Referring to FIG. 7, before a shifting of the second column spacer CS2, a gap between the second column spacer CS2 and the lower alignment film of the opening area PA is ΔH, and after the shifting of the second column spacer CS2, a gap between the second column spacer CS2 and the lower alignment film of the opening area PA is ΔH + H1, wherein H1 is the first height H1 of the first dam DM1. Since a gap ΔH between the second column spacer CS2 and the lower alignment film of the opening area PA is further increased by the first height H1 of the first dam DM1, the second column spacer CS2 can be prevented from damaging the lower alignment film of the opening area PA. In addition, even when the second column spacer CS2 is shifted by a large external force and pressed toward the lower substrate 110, the second column spacer CS2 can be supported by the second dam DM2, thereby preventing or minimizing the second column spacer CS2 from encroaching the opening area PA.

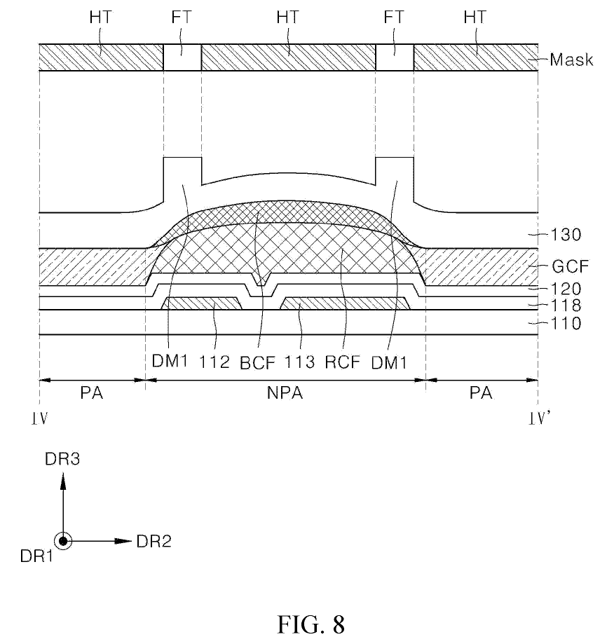

FIG. 8 is a view for describing a method of manufacturing a display device according to one example embodiment of the present disclosure.

Referring to FIG. 8, the organic layer 130 including the first dam DM1 can be formed by coating a photosensitive organic material covering the color filters RCF, GCF, and BCF and patterning the photosensitive organic material using a halftone mask Mask. The organic material can remain thick at a position corresponding to a full tone area FT, and the organic material can remain thin at a position corresponding to a half tone area HT.

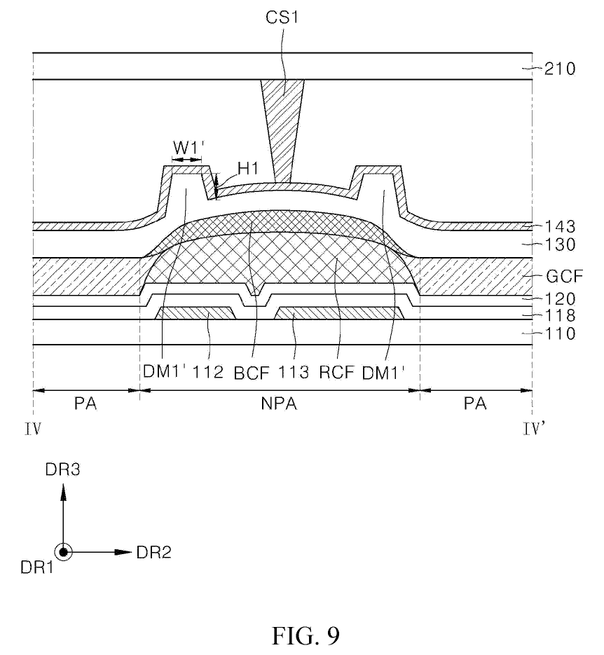

FIG. 9 is a cross-sectional view of the display device according to one example embodiment of the present disclosure. The example embodiment shown in FIG. 9 differs from the example embodiment shown in FIG. 4 in that it has a first dam DM1’.

Referring to FIG. 9, the organic layer 130 can include two first dams DM1’ spaced apart from each other in the second direction DR2. The first dams DM1’ can protrude from the upper surface of the organic layer 130. The first dams DM1’ can be formed integrally with the organic layer 130. The first dams DM1’ can have first widths W1’ in the second direction DR2 and the first heights H1 in a third direction DR3. The first widths W1’ can be a width in the second direction DR2. The first height H1 can be the shortest distance from an upper end of the first dam DM1’ to the upper surface of the organic layer 130. The first height H1 can be a height of an inner side surface of the first dam DM1’. The inner side surface of the first dam DM1’ can be a side surface facing to another adjacent first dam DM1’. The first width W1’ can be a distance between side surfaces facing to each other of any one of the two first dams DM1’. For example, the first width W1’ can be a shortest distance between side surfaces facing to each other of any one of the two first dams DM1’. The first widths W1’ of the first dams DM1’ can be larger than the diameter CD1 (of the lower end portion) of the first column spacer CS1. Side surfaces of the first dams DM1’ toward the first column spacer CS1 can be inclined so that the widths of the first dams DM1’ become narrower as they move away from the lower substrate 110. The inclination of the side surfaces of the first dams DM1’ can guide the first column spacer CS1 to return to its normal position when an external force is removed.

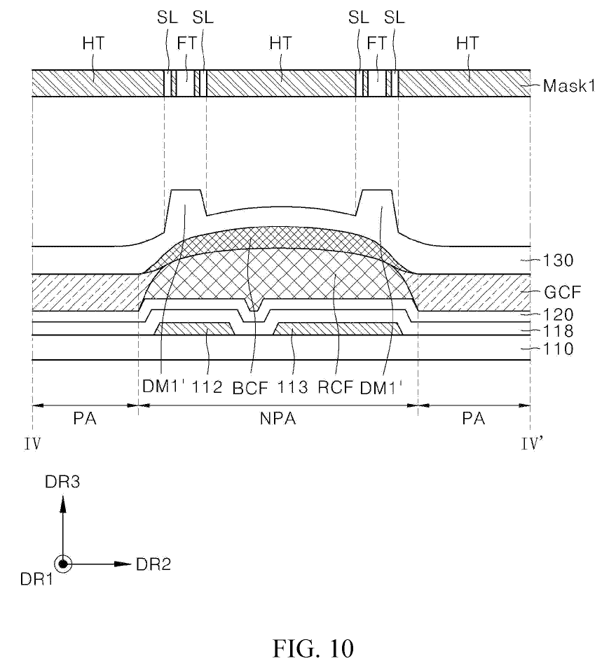

FIG. 10 is a view for describing a method of manufacturing a display device according to one example embodiment of the present disclosure.

Referring to FIG. 10, the organic layer 130 including the first dam DM1’ can be formed by coating a photosensitive organic material covering the color filters RCF, GCF, and BCF and patterning the photosensitive organic material using a halftone mask Mask1. The organic material can remain thick at a position corresponding to a full tone area FT, and the organic material can remain thin at a position corresponding to a half tone area HT. Compared to FIG. 8, by reducing the width of the full tone area FT and arranging slit patterns SL (full tone) at a predetermined distance on both sides of the full tone area FT, the side surfaces of the first dam DM1’ can be formed to be inclined.

A liquid crystal display device according to various example embodiments of the present disclosure can be described as follows.

According to example embodiments of the present disclosure, there is provided a liquid crystal display device including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, a plurality of color filters stacked on the gate line and the common line in the non-opening area of the lower substrate, an organic layer disposed on the plurality of color filters in the non-opening area of the lower substrate, and a first column spacer and a second column spacer that are disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to some example embodiments of the present disclosure, the organic layer can further include two second dams protruding from the upper surface of the organic layer in the non-opening area of the lower substrate and spaced apart from each other in the second direction, in which the second dams can be spaced apart from the first dams in the first direction, and the second column spacer can be positioned between the two second dams.

According to some example embodiments of the present disclosure, a gap between the second column spacer and the second dam can be larger than or equal to a gap between the first column spacer and the first dam.

According to some example embodiments of the present disclosure, a height of the second column spacer can be smaller than a height of the first column spacer, and heights of the second dams can be smaller than heights of the first dams.

According to some example embodiments of the present disclosure, one of the first dams can overlap the gate line, and the other of the first dams can overlap the common line.

According to some example embodiments of the present disclosure, the first dams can have a bar shape having a first length in the first direction and a first width in the second direction, first widths of the first dams can be larger than a minimum diameter of the first column spacer, and first lengths of the first dams can be larger than the minimum diameter of the first column spacer.

According to some example embodiments of the present disclosure, one of the second dams can overlap the gate line, and the other of the second dams can overlap the common line.

According to some example embodiments of the present disclosure, the second dams can have a bar shape having a second length in the first direction and a second width in the second direction, second widths of the second dams can be smaller than a minimum diameter of the second column spacer, and second lengths of the second dams can be equal to the minimum diameter of the second column spacer.

According to some example embodiments of the present disclosure, side surfaces of the first dams toward the first column spacer can be inclined so that the widths of the first dams become narrower as they move away from the lower substrate.

According to some example embodiments of the present disclosure, the plurality of color filters can include a red color filter and a blue color filter.

According to some example embodiments of the present disclosure, the red color filter and the blue color filter overlap with each other in the non-opening area of the lower substrate.

According to some example embodiments of the present disclosure, the liquid crystal display device can further comprise a first electrode and a second electrode, each of which has a bent structure.

According to some example embodiments of the present disclosure, the first electrode includes two or more first branches and first connection portions connecting the first branches, the first branches having a bent structure, and the second electrode includes two or more second branches and second connection portions connecting the second branches, the second branches having a bent structure.

According to some example embodiments of the present disclosure, the first branches of the first electrode and the second branches of the second electrode are alternately disposed in the opening area.

According to example embodiments of the present disclosure, there is provided a liquid crystal display device including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, an organic layer disposed on the gate line and the common line in the non-opening area of the lower substrate, and a first column spacer and a second column spacer disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to some example embodiments of the present disclosure, the organic layer can further include two second dams protruding from the upper surface of the organic layer in the non-opening area of the lower substrate and spaced apart from each other in the second direction, in which the second dams can be spaced apart from the first dams in the first direction, and the second column spacer can be positioned between the two second dams.

According to some example embodiments of the present disclosure, a gap between the second column spacer and the second dam can be larger than or equal to a gap between the first column spacer and the first dam.

According to some example embodiments of the present disclosure, a height of the second column spacer can be smaller than a height of the first column spacer, and heights of the second dams can be smaller than heights of the first dams.

According to some example embodiments of the present disclosure, one of the first dams can overlap the gate line, and the other of the first dams can overlap the common line.

According to some example embodiments of the present disclosure, the first dams can have a bar shaped having a first length in the first direction and a first width in the second direction, first widths of the first dams can be larger than a minimum diameter of the first column spacer, and first lengths of the first dams can be larger than the minimum diameter of the first column spacer.

According to some example embodiments of the present disclosure, one of the second dams can overlap the gate line, and the other of the second dams can overlap the common line.

According to some example embodiments of the present disclosure, the second dams can have a bar shape having a second length in the first direction and a second width in the second direction, second widths of the second dams can be smaller than a minimum diameter of the second column spacer, and second lengths of the second dams can be equal to the minimum diameter of the second column spacer.

According to some example embodiments of the present disclosure, side surfaces of the first dams toward the first column spacer can be inclined so that the widths of the first dams become narrower as they move away from the lower substrate.

According to some example embodiments of the present disclosure, the liquid crystal display device can further comprise a first electrode and a second electrode, each of which has a bent structure.

According to some example embodiments of the present disclosure, the first electrode includes two or more first branches and first connection portions connecting the first branches, the first branches having a bent structure, and the second electrode includes two or more second branches and second connection portions connecting the second branches, the second branches having a bent structure.

According to some example embodiments of the present disclosure, the first branches of the first electrode and the second branches of the second electrode are alternately disposed in the opening area.

According to example embodiments of the present disclosure, there is provided a liquid crystal display panel including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, a plurality of color filters stacked on the gate line and the common line in the non-opening area of the lower substrate, an organic layer disposed on the plurality of color filters in the non-opening area of the lower substrate, and a first column spacer and a second column spacer that are disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

According to example embodiments of the present disclosure, there is provided a liquid crystal display panel including a lower substrate including an opening area through which light transmits to implement a color and a non-opening area in which a gate line and a common line that extend in a first direction are disposed, an upper substrate disposed to face the lower substrate, a liquid crystal layer disposed between the lower substrate and the upper substrate, an organic layer disposed on the gate line and the common line in the non-opening area of the lower substrate, and a first column spacer and a second column spacer disposed on a lower surface of the upper substrate and spaced apart from each other in the first direction. The organic layer can include two first dams protruding from an upper surface of the organic layer in the non-opening area of the lower substrate and spaced apart from each other in a second direction intersecting the first direction, and the first column spacer can be positioned between the two first dams.

Although the example embodiments of the present disclosure have been described in more detail with reference to the accompanying drawings, the present disclosure is not necessarily limited to these example embodiments, and various modifications can be carried out without departing from the technical spirit of the present disclosure. Accordingly, the example embodiments disclosed in the present disclosure are not intended to limit the technical spirit of the present disclosure, but are intended to describe the technical spirit of the present disclosure and the scope of the technical spirit of the present disclosure is not limited by these example embodiments. Accordingly, it should be understood that the above-described example embodiments are illustrative and not restrictive in all aspects.

What is claimed is:

1. A liquid crystal display device comprising:
a lower substrate including an opening area through which light is configured to transmit to implement a color, and a non-opening area in which a gate line and a common line that extend in a first direction are disposed;
an upper substrate disposed to face the lower substrate;
a liquid crystal layer disposed between the lower substrate and the upper substrate;
a plurality of color filters stacked on the gate line and the common line in the non-opening area of the lower substrate;
an organic layer disposed on the plurality of color filters in the non-opening area of the lower substrate; and
a first column spacer and a second column spacer that are disposed on a lower surface of the upper substrate and spaced apart from each other in the first direction,
wherein the organic layer includes two first dams protruding from an upper surface of the organic layer in the non-opening area of the lower substrate and being spaced apart from each other in a second direction intersecting the first direction, and
wherein the first column spacer is positioned between the two first dams.

2. The liquid crystal display device of claim 1, wherein the organic layer further includes two second dams protruding from the upper surface of the organic layer in the non-opening area of the lower substrate and being spaced apart from each other in the second direction,
wherein the two second dams are spaced apart from the two first dams in the first direction, and
wherein the second column spacer is positioned between the two second dams.

3. The liquid crystal display device of claim 2, wherein a gap between the second column spacer and one of the two second dams is larger than or equal to a gap between the first column spacer and one of the two first dams.

4. The liquid crystal display device of claim 2, wherein a height of the second column spacer is smaller than a height of the first column spacer, and heights of the two second dams are smaller than heights of the two first dams.

5. The liquid crystal display device of claim 1, wherein one of the two first dams overlaps the gate line, and the other of the two first dams overlaps the common line.

6. The liquid crystal display device of claim 1, wherein the two first dams have a bar shape having a first length in the first direction and a first width in the second direction, and
wherein first widths of the two first dams are larger than a minimum diameter of the first column spacer, and first lengths of the two first dams are larger than the minimum diameter of the first column spacer.

7. The liquid crystal display device of claim 2, wherein one of the two second dams overlaps the gate line, and the other of the two second dams overlaps the common line.

8. The liquid crystal display device of claim 2, wherein the two second dams have a bar shape having a second length in the first direction and a second width in the second direction, and
wherein second widths of the two second dams are smaller than a minimum diameter of the second column spacer, and second lengths of the two second dams are equal to the minimum diameter of the second column spacer.

9. The liquid crystal display device of claim 1, wherein side surfaces of the two first dams toward the first column spacer are inclined so that widths of the two first dams become narrower as being away from the lower substrate.

10. The liquid crystal display device of claim 1, wherein the plurality of color filters include a red color filter and a blue color filter.

11. A liquid crystal display device comprising:
a lower substrate including an opening area through which light is configured to implement a color, and a non-opening area in which a gate line and a common line that extend in a first direction are disposed;
an upper substrate disposed to face the lower substrate;
a liquid crystal layer disposed between the lower substrate and the upper substrate;
an organic layer disposed on the gate line and the common line in the non-opening area of the lower substrate; and
a first column spacer and a second column spacer that are disposed on a lower surface of the upper substrate and spaced apart from each other in the first direction,
wherein the organic layer includes two first dams protruding from an upper surface of the organic layer in the non-opening area of the lower substrate and being spaced apart from each other in a second direction intersecting the first direction, and
wherein the first column spacer is positioned between the two first dams.

12. The liquid crystal display device of claim 11, wherein the organic layer further includes two second dams protruding from the upper surface of the organic layer in the non-opening area of the lower substrate and being spaced apart from each other in the second direction,
wherein the two second dams are spaced apart from the two first dams in the first direction, and
wherein the second column spacer is positioned between the two second dams.

13. The liquid crystal display device of claim 12, wherein a gap between the second column spacer and one of the two second dams is larger than or equal to a gap between the first column spacer and one of the two first dams.

14. The liquid crystal display device of claim 12, wherein a height of the second column spacer is smaller than a height of the first column spacer, and heights of the two second dams are smaller than heights of the two first dams.

15. The liquid crystal display device of claim 11, wherein one of the two first dams overlaps the gate line, and the other of the two first dams overlaps the common line.

16. The liquid crystal display device of claim 11, wherein the two first dams have a bar shape having a first length in the first direction and a first width in the second direction, and
wherein first widths of the two first dams are larger than a minimum diameter of the first column spacer, and first lengths of the two first dams are larger than the minimum diameter of the first column spacer.

17. The liquid crystal display device of claim 12, wherein one of the two second dams overlaps the gate line, and the other of the two second dams overlaps the common line.

18. The liquid crystal display device of claim 12, wherein the two second dams have a bar shape having a second length in the first direction and a second width in the second direction, and
wherein second widths of the two second dams are smaller than a minimum diameter of the second column spacer, and second lengths of the two second dams are equal to the minimum diameter of the second column spacer.

19. The liquid crystal display device of claim 11, wherein side surfaces of the two first dams toward the first column spacer are inclined so that widths of the two first dams become narrower as being away from the lower substrate.

20. A liquid crystal display panel comprising:
a lower substrate including an opening area through which light is configured to transmit to implement a color, and a non-opening area in which a gate line and a common line that extend in a first direction are disposed;
an upper substrate disposed to face the lower substrate;
a liquid crystal layer disposed between the lower substrate and the upper substrate;
an organic layer disposed on the gate line and the common line in the non-opening area of the lower substrate; and
a first column spacer and a second column spacer that are disposed on a lower surface of the upper substrate and spaced apart from each other in the first direction,
wherein the organic layer includes a plurality of dams that protrude from an upper surface of the organic layer in the non-opening area of the lower substrate and that are spaced apart from each other in a second direction intersecting the first direction, and
wherein the first column spacer is positioned between the plurality of dams.
